(19) United States
(12) Patent Application Publication
(10) Pub. No.: US 2026/0266348 A1
(43) Pub. Date: Sep. 10, 2026

(54) ANTI-VIBRATION RUBBER

(71) Applicant: Isuzu Motors Limited, Kanagawa (JP)

(72) Inventors: Nithet BOONYOO, Samutprakan (TH); Rianpanya FA-AMNUYPOL, Samutprakan (TH); Nuttapon OCHAPANTH, Samutprakan (TH); Amata CHAMUNGHATTHAPONG, Samutprakan (TH); Pathompong BOONPHAN, Samutprakan (TH)

(73) Assignee: Isuzu Motors Limited, Kanagawa (JP)

(21) Appl. No.: 19/557,197

(22) Filed: Mar. 5, 2026

(30) Foreign Application Priority Data
Mar. 7, 2025 (JP) 2025-036356

(51) Int. Cl. F16F 1/38; B60K 1/00

(52) U.S. Cl. CPC F16F 1/3828; B60K 1/00; F16F 2224/025

(57) ABSTRACT

An anti-vibration rubber includes: a cylindrical collar member including a through-hole; a rubber member fitted onto an outer periphery of the collar member and including a fitting hole; and an outer member fitted onto an outer periphery of the rubber member. The collar member includes, alternately arranged around the through-hole axis, collar protrusions protruding outward as viewed in an axial direction of the through-hole and collar recesses each formed between the collar protrusions. The rubber member includes rubber recesses and rubber protrusions formed on an inner surface of the fitting hole. The collar protrusion is fitted into the rubber recess, and the rubber protrusion is fitted into the collar recess so that the rubber member is in close contact with and fitted onto the outer periphery of the collar member. A slit is formed on an outer peripheral side of the rubber recess in the rubber member.

### RELATED APPLICATION

This application claims the benefit of priority of Japanese Patent Application No.2025-036356 filed on Mar. 7, 2025, the disclosure of which including the specification, drawings and abstract is incorporated herein by reference in its entirety.

### TECHNICAL FIELD

The present disclosure relates to an anti-vibration rubber.

### BACKGROUND ART

In the related art, a structure in which a motor for driving of an electric vehicle or the like is attached to a chassis via a mounting member is known. The motor for driving vibrates due to vibration caused by rotation of the motor or vibration transmitted from the wheels. In order to absorb this vibration, a rubber bush is used as the mounting member. The rubber bush is generally a member made of rubber having a substantially cylindrical shape, serving to absorb vibration and reduce vibration transmitted to the chassis (PTL 1).

### Citation List

### Patent Literature

PTL 1

Japanese Patent Application Laid-Open No. 2020-131931

### SUMMARY OF INVENTION

### Technical Problem

A motor for driving may vibrate particularly in the longitudinal direction due to vibration transmitted from the wheels, but a conventional rubber bush has a substantially cylindrical shape therefore cannot sufficiently absorb vibration of the motor for driving in the longitudinal direction. As a result, vibration of the motor for driving may be transmitted to the chassis, potentially adversely affecting ride comfort or the like due to vibration, noise, or the like.

The present disclosure has been made in view of the above-described problem of the related art, and an object thereof is to provide an anti-vibration rubber that effectively absorbs vibration in a specific direction.

### Solution to Problem

The anti-vibration rubber of the present disclosure is an anti-vibration rubber including: a collar member that is cylindrical, the collar member including a through-hole; a rubber member to be fitted onto an outer periphery of the collar member, the rubber member including a fitting hole formed therein; and an outer member fitted onto an outer periphery of the rubber member, in which the collar member includes a plurality of collar protrusions and a plurality of collar recesses alternately arranged around an axis of the through-hole, the plurality of collar protrusions protruding outward as viewed in an axial direction of the through-hole, each of the plurality of collar recesses being formed between two of the plurality of collar protrusions; the rubber member includes rubber recesses and rubber protrusions formed on an inner surface of the fitting hole; each of the plurality of collar protrusions is fitted into a corresponding one of the rubber recesses, and each of the plurality of the collar recesses is fitted onto a corresponding one of the rubber protrusions so that the rubber member is in close contact with and fitted onto the outer periphery of the collar member, and a slit is formed on an outer peripheral side of each of the rubber recesses in the rubber member.

### Advantageous Effects of Invention

According to the anti-vibration rubber of the present disclosure, a slit in a rubber member deforms, thereby effectively absorbing vibrations. In particular, the degree of ease of deformation (elastic modulus) of the rubber in the direction of the collar recess and the rubber protrusion as viewed from the through-hole is different from the elastic modulus of the rubber in the direction of the collar protrusion and the rubber recess, and therefore, vibration in a specific direction can be effectively absorbed by appropriately designing an attachment direction of the anti-vibration rubber.

### BRIEF DESCRIPTION OF THE SEVERAL VIEWS OF THE DRAWINGS

FIG. 1 illustrates a mounting structure of a motor for driving;

FIG. 2 is a perspective view of a front motor to which the anti-vibration rubber is applied;

FIG. 3 is a side view of the front motor to which the anti-vibration rubber is applied;

FIG. 4 is a perspective view of a rear motor to which the anti-vibration rubber is applied;

FIG. 5 is a side view of the rear motor to which the anti-vibration rubber is applied;

FIG. 6 is a detailed view of the anti-vibration rubber;

FIG. 7 is a partially enlarged view of the anti-vibration rubber; and

FIG. 8 is a cross-sectional view of the mounting structure of the motor to which the anti-vibration rubber is applied.

### DESCRIPTION OF EMBODIMENTS

Hereinafter, embodiments of the present disclosure will be described with reference to the drawings. It should be noted that all of the embodiments described below are specific examples of the present disclosure. Therefore, each component, the disposition positions, connection forms, and the like of the components shown in the following embodiments are examples, and do not limit the spirit of the present disclosure.

In addition, each drawing is a schematic view, and is not necessarily strictly illustrated. In the drawings, the same reference numeral is assigned to substantially the same configurations, and duplicate descriptions may be omitted or simplified. In addition, with respect to the XYZ coordinate axes in the drawing, the +X direction indicates the front of the vehicle, the +Y direction indicates the right side of the vehicle, and the +Z direction indicates the vertically upward direction of the vehicle.

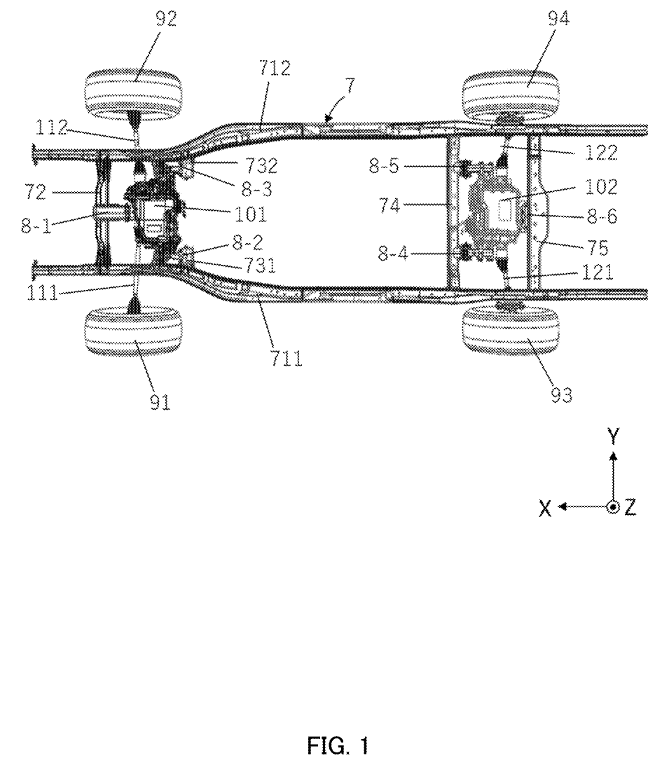

FIG. 1 illustrates a schematic configuration of a structure in which a motor for driving is attached to a chassis using the anti-vibration rubber of the present disclosure. Chassis 7 includes a pair of left and right side frames 711 and 712 extending in the longitudinal direction of the vehicle (vehicle longitudinal direction), and first cross member 72, second cross member 74, and third cross member 75 each provided between left side frame 711 and right side frame 712 in the width direction of the vehicle (vehicle width direction). Chassis 7 is configured in a ladder shape as a whole. The end portions of first cross member 72, second cross member 74, and third cross member 75 are fixed to left side frame 711 and right side frame 712.

In addition, left attachment portion 731 and right attachment portion 732 each for attaching front motor 101 are provided to protrude inward in the vehicle width direction on left side frame 711 and right side frame 712, respectively. Front motor 101 is fixed to first cross member 72 via front bracket 8-1, to left attachment portion 731 via left rear bracket 8-2, and to right attachment portion 732 via right rear bracket 8-3.

The output shaft of front motor 101 is coupled with left front drive shaft 111 and a right front drive shaft 112 via a transmission mechanism. Left front wheel 91 and right front wheel 92 are coupled with left front drive shaft 111 and right front drive shaft 112, respectively. Left front wheel 91 and right front wheel 92 are drive wheels that are rotationally driven by a driving force of front motor 101. Left front drive shaft 111 and right front drive shaft 112 are each provided so as to be slightly inclined toward the front of the vehicle as each shaft extends outward in the vehicle width direction.

Rear motor 102 is fixed to second cross member 74 via left front bracket 8-4 and right front bracket 8-5, and is fixed to third cross member 75 via rear bracket 8-6.

The output shaft of rear motor 102 is coupled with left rear drive shaft 121 and a right rear drive shaft 122 via a transmission mechanism, and left rear wheel 93 and right rear wheel 94 are coupled with left rear drive shaft 121 and right rear drive shaft 122, respectively. Left rear wheel 93 and right rear wheel 94 are drive wheels that are rotationally driven by a driving force of rear motor 102. Left rear drive shaft 121 and right rear drive shaft 122 are each provided so as to be slightly inclined toward the rear of the vehicle as each shaft extends outward in the vehicle width direction.

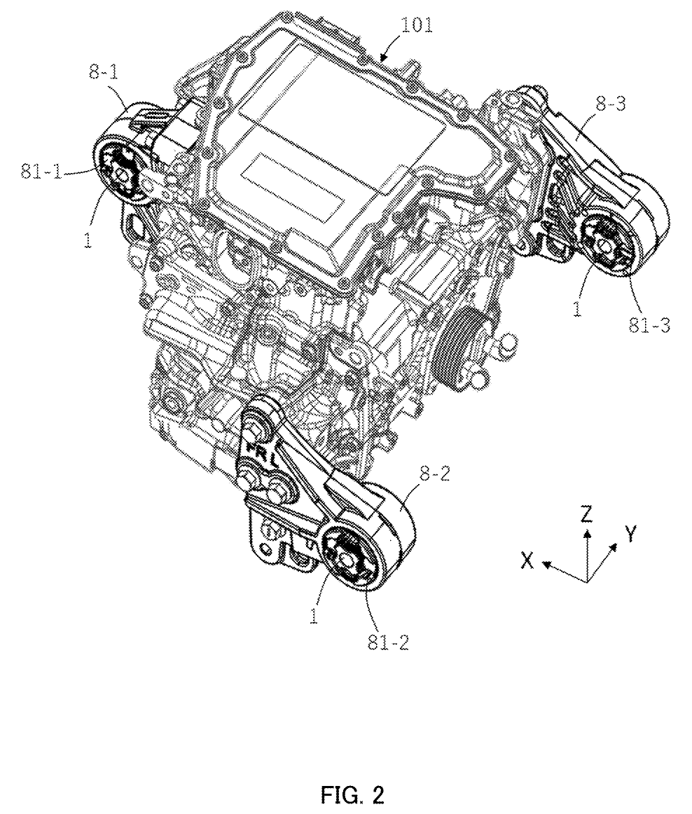

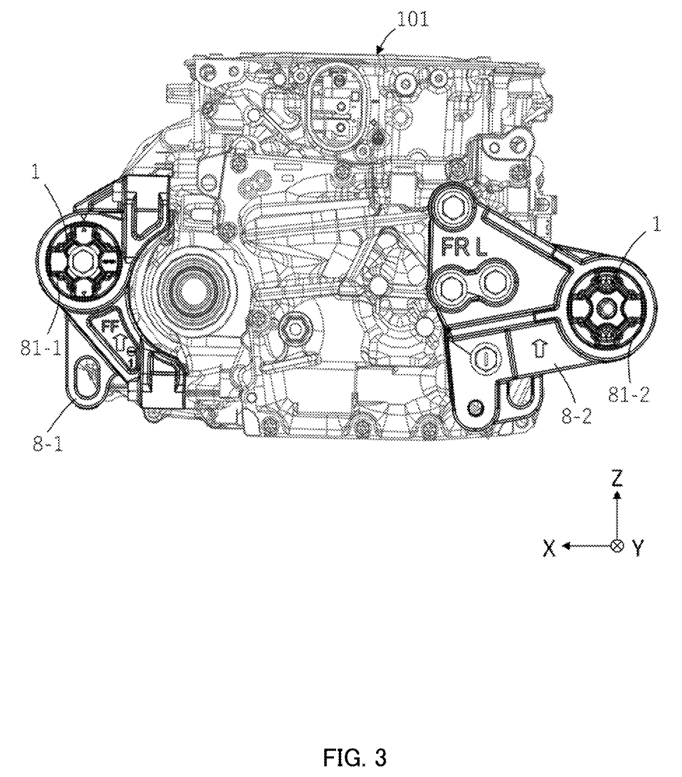

FIG. 2 is an upper left rear perspective view of front motor 101, and FIG. 3 is a left side view of front motor 101. Front bracket 8-1 is attached to the front portion of front motor 101 at substantially the center of the front portion. In addition, left rear bracket 8-2 and right rear bracket 8-3 are attached to the rear portion of front motor 101 on the left and right sides of the rear portion, respectively. Insertion holes 81-1, 81-2, and 81-3 are respectively formed in front bracket 8-1, left rear bracket 8-2, and right rear bracket 8-3, and anti-vibration rubber 1 is fitted into each of insertion holes 81-1, 81-2, and 81-3.

Anti-vibration rubber 1 of front bracket 8-1 is fastened to first cross member 72 by bolt 5 and nut 6. In addition, anti-vibration rubber 1 of left rear bracket 8-2 is fastened to left attachment portion 731 by bolt 5 and nut 6, and anti-vibration rubber 1 of right rear bracket 8-3 is fastened to right attachment portion 732 by bolt 5 and nut 6. Each anti-vibration rubber 1 is attached so that the central axis thereof is parallel to the left-right direction of the vehicle.

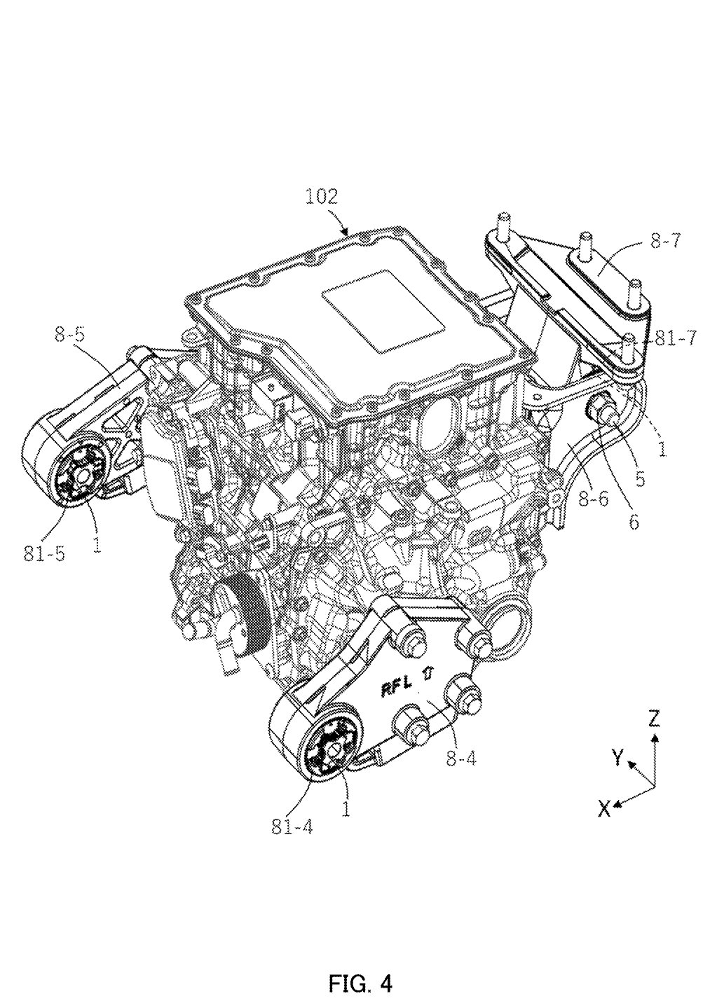

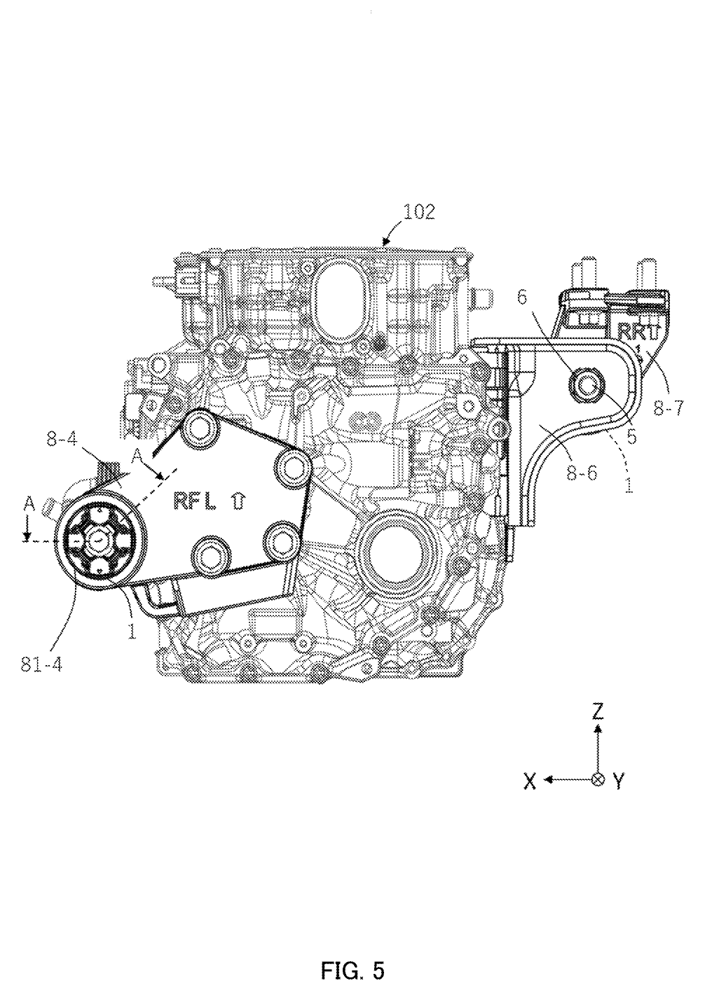

FIG. 4 is an upper left front perspective view of rear motor 102, and FIG. 5 is a left side view of rear motor 102. Left front bracket 8-4 and right front bracket 8-5 are attached to the front portion of rear motor 102 at the left and right sides of the front portion, respectively. In addition, rear bracket 8-6 is attached to the rear portion of rear motor 102 at substantially the center of the rear portion. Insertion hole 81-4 and insertion hole 81-5 are formed in left front bracket 8-4 and right front bracket 8-5, respectively, and anti-vibration rubber 1 is fitted into each of insertion holes 81-4 and 81-5.

Rear mounting bracket 8-7 is coupled with rear bracket 8-6 via anti-vibration rubber 1. Rear mounting bracket 8-7 is a bracket that is fastened to third cross member 75. Insertion hole 81-7 is formed in rear mounting bracket 8-7, and anti-vibration rubber 1 is fitted into insertion hole 81-7. Bolt 5 is inserted through the through-hole formed in rear bracket 8-6 and anti-vibration rubber 1, and nut 6 is screwed to bolt 5, thereby coupling rear bracket 8-6 with rear mounting bracket 8-7 via anti-vibration rubber 1.

Anti-vibration rubber 1 of left front bracket 8-4 and anti-vibration rubber 1 of right front bracket 8-5 are both fastened to second cross member 74 by bolts 5 and nuts 6. In addition, rear bracket 8-6 is fastened to third cross member 75 via anti-vibration rubber 1 and rear mounting bracket 8-7. Each anti-vibration rubber 1 is attached so that the central axis thereof is parallel to the left-right direction of the vehicle.

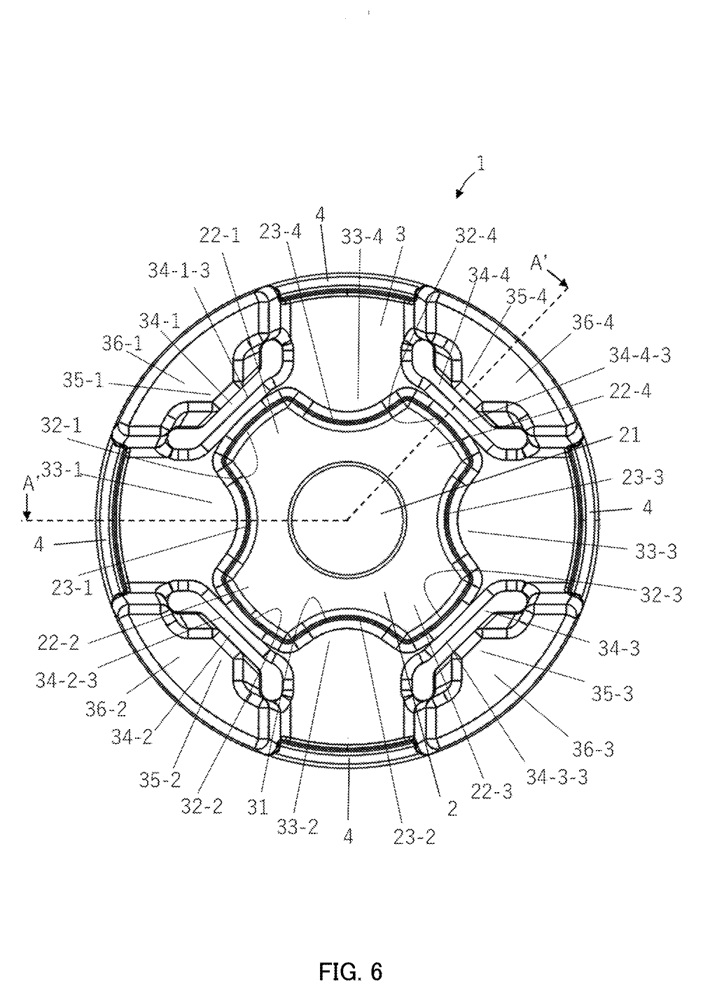

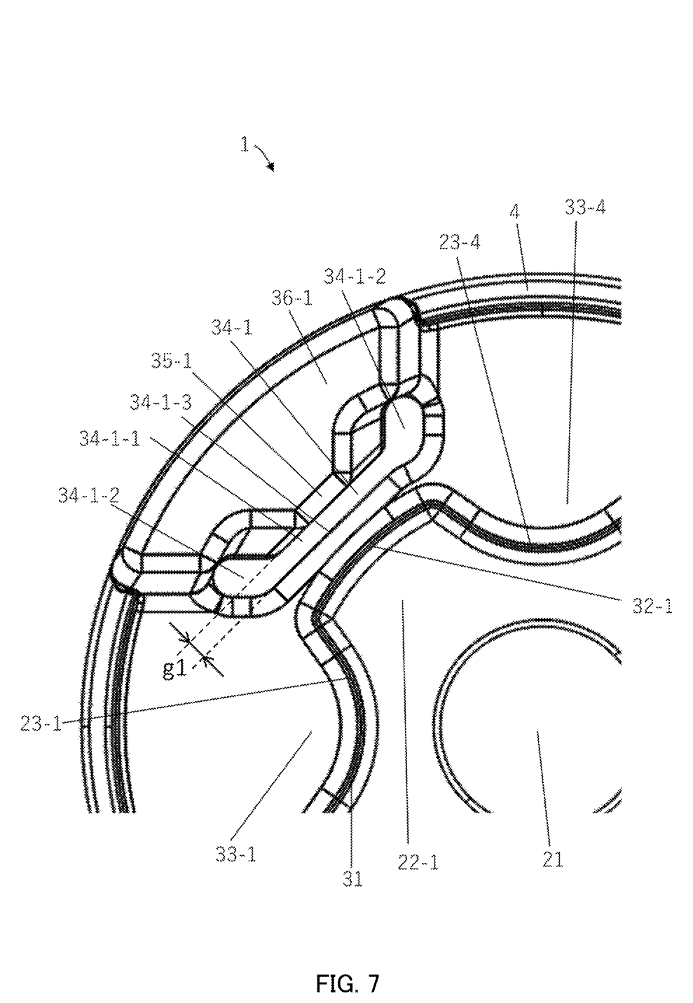

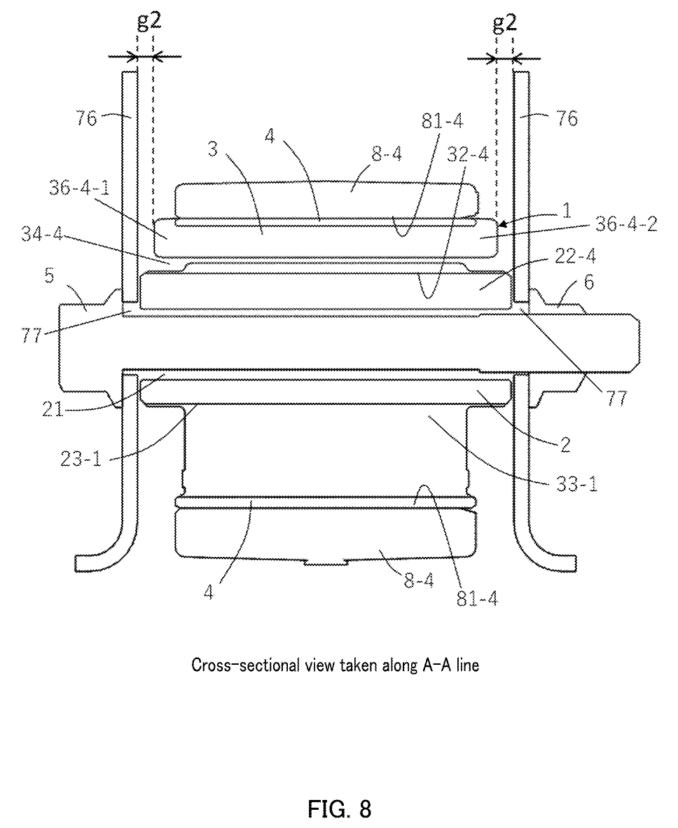

FIG. 6 illustrates details of anti-vibration rubber 1, and FIG. 7 is a partially enlarged view thereof. Although FIG. 7 illustrates the upper left portion of anti-vibration rubber 1 illustrated in FIG. 6, the structure of anti-vibration rubber 1 has a symmetrical shape around the central axis, and thus the upper right portion, the lower left portion, and the lower right portion also have substantially the same structure as that of the upper left portion. In addition, FIG. 8 is a cross-sectional view taken along an A-A line of FIG. 5. The A’-A’ line of FIG. 6 corresponds to the A-A line of FIG. 5. Although FIG. 8 illustrates a structure in which left front bracket 8-4 is attached to second cross member 74, substantially the same structure is applied to all the structures in which front bracket 8-1 is attached to first cross member 72, left rear bracket 8-2 is attached to left attachment portion 731, right rear bracket 8-3 is attached to right attachment portion 732, and left front bracket 8-4 and right front bracket 8-5 are attached to second cross member 74. Therefore, the structure illustrated in FIG. 8 can also be applied to the attachment structures of other brackets.

Anti-vibration rubber 1 includes collar member 2, rubber member 3, and outer member 4. Collar member 2 includes, in the center thereof, through-hole 21 through which bolt 5 for attachment is inserted, and which is formed of metal or resin. The outer surface of collar member 2 includes a plurality of (four in the present embodiment) collar protrusions 22-1, 22-2, 22-3, and 22-4 that radially protrude outward as viewed from the axial direction of through-hole 21, and collar recesses 23-1, 23-2, 23-3, and 23-4 formed between adjacent collar protrusions 22-1, 22-2, 22-3, and 22-4. Collar protrusions 22-1, 22-2, 22-3, and 22-4 and collar recesses 23-1, 23-2, 23-3, and 23-4 are alternately disposed at equal intervals around through-hole 21. In the present embodiment, the four collar protrusions 22-1, 22-2, 22-3, and 22-4 are formed around through-hole 21 at equal intervals of 90 degrees.

Rubber member 3 is a rubber member that is fitted onto the outer side of collar member 2. Rubber member 3 includes, in the center thereof, fitting hole 31, and collar member 2 is fitted in fitting hole 31. Fitting hole 31 includes, formed on the inner surface thereof, rubber recesses 32-1, 32-2, 32-3, and 32-4 corresponding to collar protrusions 22-1, 22-2, 22-3, and 22-4, and rubber protrusions 33-1, 33-2, 33-3, and 33-4 corresponding to collar recesses 23-1, 23-2, 23-3, and 23-4 so that collar member 2 is in close contact with and fitted in fitting hole 31.

Slits 34-1, 34-2, 34-3, and 34-4 are formed on the outer peripheral side of rubber recesses 32-1, 32-2, 32-3, and 32-4. Each slit extends through a corresponding rubber recess in the central axis direction (direction vertical to the drawing in FIG. 6) of anti-vibration rubber 1. Since slits 34-1, 34-2, 34-3, and 34-4 have the same shape, slit 34-1 will be described in detail with reference to FIG. 7. Slit 34-1 includes central portion 34-1-1 and end portions 34-1-2 formed at both end of central portion 34-1-1. Central portion 34-1-1 is flat in the circumferential direction of slit 34-1 as viewed from the central axis of anti-vibration rubber 1. End portion 34-1-2 is thicker than central portion 34-1-1 and is formed to be slightly displaced in the outer peripheral direction. Stopper portion 35-1 is formed opposite to collar protrusion 22-1 and the rubber recess 32-1 with slit 34-1 in between. Stopper portion 35-1 is formed to protrude inward from the outer peripheral side of slit 34-1 and faces opposing wall portion 34-1-3 located inside slit 34-1 with gap g1 therebetween.

In addition, as illustrated in FIG. 8, protruding portions 36-1, 36-2, 36-3, and 36-4 that protrude in the central axis direction of anti-vibration rubber 1 are formed on slits 34-1, 34-2, 34-3, and 34-4 of rubber member 3 at the sites on the outer peripheral side (FIG. 8 illustrates protruding portion 36-4 by reference numerals 36-4-1 and 36-4-2). Therefore, the length of rubber member 3 in the central axis direction is longer at the outer peripheral side portions of slits 34-1, 34-2, 34-3, and 34-4 than at other portions.

A substantially cylindrical outer member 4 is fitted onto the outer periphery of rubber member 3. Outer member 4 configured to protect the anti-vibration rubber formed of resin or metal from wear and the like.

Anti-vibration rubber 1 is inserted into insertion holes 81-1, 81-2, 81-3, 81-4, 81-5, and 81-7 of brackets 8-1, 8-2, 8-3, 8-4, 8-5, and 8-7 for attaching front motor 101 and rear motor 102 to chassis 7. FIG. 8 illustrates a state in which anti-vibration rubber 1 inserted into insertion hole 81-4 of left front bracket 8-4 (i.e., one of the above brackets) of rear motor 102 is fastened to attachment portions 76 and 76 formed in second cross member 74. Rear motor 102 is positioned so that the attachment hole 77 formed in attachment portion 76 and through-hole 21 become substantially linear, and bolt 5 is inserted through the attachment hole 77 and through-hole 21. Rear motor 102 is attached to attachment portion 76 of chassis 7 by screwing nut 6 to bolt 5 and tightening it. At this time, the length of collar member 2 is slightly shorter than the distance between attachment portions 76 and 76, and thus anti-vibration rubber 1 is fitted between attachment portions 76 and 76. Protruding portion 36 faces attachment portions 76 and 76 with a slight gap g2.

Next, the manner in which anti-vibration rubber 1 of the present embodiment absorbs vibration while a vehicle is traveling, with a motor attached to a chassis using anti-vibration rubber 1, will be described. When the motor and chassis are subjected to vibrations caused by the rotation of the motor, or vibrations input to the motor from the road surface through the wheels and drive shaft, the motor and chassis move relative to each other due to the vibrations.

When the motor vibrates with respect to the chassis, the bracket attached to the motor also vibrates with the motor. When the bracket vibrates, outer member 4 of anti-vibration rubber 1 fitted into the insertion hole of the bracket also vibrates. On the other hand, collar member 2 fastened to chassis 7 by bolt 5 and nut 6 hardly vibrates with respect to chassis 7. Therefore, collar member 2 and outer member 4 vibrate relative to each other.

In the following description, it is assumed that outer member 4 vibrates with respect to collar member 2, but the same applies to the case where collar member 2 vibrates with respect to outer member 4. When collar member 2 and outer member 4 vibrate, rubber member 3 located between collar member 2 and outer member 4 is deformed. Since slits 34 are formed in rubber member 3, a part of slits 34 is deformed to be flattened. For example, in FIG. 6, when outer member 4 vibrates in the horizontal direction (left-right direction in FIG. 6) with respect to collar member 2, outer member 4 repeats the movement to the right so as to flatten slits 34-1 and 34-2 and to the left so as to flatten slits 34-3 and 34-4.

When outer member 4 moves to the right, in rubber member 3, rubber protrusion 33-1 on the left side of collar member 2 is elastically deformed to be compressed, rubber protrusion 33-3 on the right side of collar member 2 is elastically deformed to be extended, and rubber protrusion 33-4 on the upper side of collar member 2 and rubber protrusion 33-2 on the lower side of collar member 2 are elastically deformed by a shearing force. When the amplitude is large, slits 34-1 and 34-2 are flattened, and stopper portions 35-1 and 35-2 come into contact with the opposing wall portions 34-1-3 and 34-2-3, and thus stopper portions 35-1 and 35-2 do not move further. Therefore, the maximum amplitude is restricted to the value until stopper portions 35-1 and 35-2 come into contact with the opposing wall portions 34-1-3 and 34-2-3, that is, to g1 ÷ cos45°.

In addition, when outer member 4 moves to the left, in rubber member 3, rubber protrusion 33-3 on the right side of collar member 2 is elastically deformed to be compressed, rubber protrusion 33-1 on the left side of collar member 2 is elastically deformed to be extended, and rubber protrusion 33-4 on the upper side of collar member 2 and rubber protrusion 33-2 on the lower side of collar member 2 are elastically deformed by a shearing force. When the amplitude is large, slits 34-3 and 34-4 are flattened, and stopper portions 35-3 and 35-4 come into contact with the opposing wall portions 34-3-3 and 34-4-3, and thus stopper portions 35-3 and 35-4 do not move further. Therefore, the maximum amplitude is restricted to the value until stopper portions 35-3 and 35-4 come into contact with the opposing wall portions 34-3-3 and 34-4-3, that is, to g1 ÷ cos45°.

Next, the case where outer member 4 vibrates with respect to collar member 2 in a direction of a diagonal line of 45 degrees connecting an upper left side and a lower right side in FIG. 6 will be described. When outer member 4 moves to the lower right, in rubber member 3, rubber protrusion 33-1 on the left side of collar member 2 and rubber protrusion 33-4 on the upper side of collar member 2 are elastically deformed to be compressed and sheared in the lower right direction, and rubber protrusion 33-2 on the lower side of collar member 2 and rubber protrusion 33-3 on the right side of collar member 2 are elastically deformed to be extended and sheared in the lower right direction. When the amplitude is large, slit 34-1 is flattened, and stopper portion 35-1 comes into contact with the opposing wall portion 34-1-3, and thus stopper portion 35-1 does not move further. Therefore, the maximum amplitude is restricted to the value until stopper portion 35-1 comes into contact with the opposing wall portion 34-1-3, that is, to g1.

In addition, when outer member 4 moves to the upper left, in rubber member 3, rubber protrusion 33-3 on the right side of collar member 2 and rubber protrusion 33-2 on the lower side of collar member 2 are elastically deformed to be compressed and sheared in the upper left direction, and rubber protrusion 33-4 on the upper side of collar member 2 and rubber protrusion 33-1 on the left side of collar member 2 are elastically deformed to be extended and sheared in the upper left direction. When the amplitude is large, slit 34-3 is flattened, and stopper portion 35-3 comes into contact with the opposing wall portion 34-3-3, and thus stopper portion 35-3 does not move further. Therefore, the maximum amplitude is restricted to the value until stopper portion 35-3 comes into contact with the opposing wall portion 34-3-3, that is, to g1.

As described above, in FIG. 6, the deformation form of rubber member 3 is different between the case where collar member 2 vibrates in the left-right direction and the case where collar member 2 vibrates in the upper left-lower right direction. Therefore, the ease of deformation (elastic modulus) of rubber member 3 is different between the above in cases. That is, in FIG. 6, rubber member 3 is less likely to be deformed when the collar member vibrates in a direction in which rubber protrusions face each other, such as in the left-right direction or the up-down direction than in when the collar member vibrates in a direction in which slits face each other, such as in the upper left-lower right direction or the upper right-lower left direction. Therefore, the vibration can be appropriately absorbed by appropriately setting an orientation of the installation of anti-vibration rubber 1.

As illustrated in FIG. 1, in the case where left front drive shaft 111 and right front drive shaft 112 are provided so as to be slightly inclined with respect to front motor 101 toward the front of the vehicle as each shaft extends outward in the vehicle width direction, when vibration transmitted in the axial direction of left front drive shaft 111 and vibration transmitted in the axial direction of right front drive shaft 112 are combined, front motor 101 is more likely to vibrate in the vehicle longitudinal direction. In addition, in the case where left rear drive shaft 121 and right rear drive shaft 122 are provided so as to be slightly inclined with respect to rear motor 102 toward the rear side of the vehicle as each shaft extends outward in the vehicle width direction, when vibration transmitted in the axial direction of left rear drive shaft 121 and vibration transmitted in the axial direction of right rear drive shaft 122 are combined, rear motor 102 is more likely to vibrate in the vehicle longitudinal direction. Therefore, by installing anti-vibration rubber 1 so that the collar recess is parallel to the vehicle longitudinal direction, the vibration in the vehicle longitudinal direction is easily absorbed.

Next, the case where outer member 4 vibrates in the left-right direction with respect to collar member 2 in FIG. 8, that is, the case where outer member 4 vibrates in the central axis direction of anti-vibration rubber 1 will be described. When outer member 4 moves to the left side of the drawing by g2, protruding portion 36-4-1 of rubber member 3 comes into contact with attachment portion 76 on the left to restrict further movement of outer member 4. In addition, when outer member 4 moves to the right side by g2, protruding portion 36-4-2 of rubber member 3 comes into contact with attachment portion 76 on the right to restrict further movement of outer member 4. Therefore, the maximum amplitude is restricted to the value until protruding portions 36-4-1 and 36-4-2 come into contact with attachment portions 76, that is, to g2. As described above, the vibration in the axial direction (left-right direction in FIG. 8) of anti-vibration rubber 1 can be appropriately absorbed by preventing the amplitude from being excessive.

Although the embodiment has been described by giving an example of applying the anti-vibration rubber of the present disclosure to a mounting structure for attaching a motor for driving to a chassis, the application of the anti-vibration rubber is not limited to the mounting structure. The anti-vibration rubber can also be applied to various vibration damping structures such as an installation structure of a device that generates vibration. In addition, in the above-described embodiment, four collar protrusions are formed at equal intervals around the through-hole, and four collar recesses are formed at equal intervals around the through-hole, but the number of the collar protrusions and the collar recesses is not limited thereto and may be appropriately changed depending on the vibration damping structure to be applied. In addition, the protrusion portion height of the stopper can be appropriately designed depending on the allowable amplitude or the like. In addition, the orientation of the collar protrusion as viewed in the axial direction of the through-hole can be appropriately designed depending on the direction, the magnitude, or the like of the generated vibration.

### INDUSTRIAL APPLICABILITY

The anti-vibration rubber can be suitably applied to a vibration damping structure such as a mounting structure of a motor for driving.

### REFERENCE SIGNS LIST

1 Anti-vibration rubber

2 Collar member

21 Through-hole

3 Rubber member

31 Fitting hole

4 Outer member

5 Bolt

6 Nut

7 Chassis

8 Bracket

9 Wheel

101 Front motor

102 Rear motor

What is claimed is:

1. An anti-vibration rubber, comprising:
a collar member that is cylindrical, the collar member including a through-hole;
a rubber member to be fitted onto an outer periphery of the collar member, the rubber member including a fitting hole formed therein; and
an outer member fitted onto an outer periphery of the rubber member, wherein
the collar member includes a plurality of collar protrusions and a plurality of collar recesses alternately arranged around an axis of the through-hole, the plurality of collar protrusions protruding outward as viewed in an axial direction of the through-hole, each of the plurality of collar recesses being formed between two of the plurality of collar protrusions,
the rubber member includes rubber recesses and rubber protrusions formed on an inner surface of the fitting hole,
each of the plurality of collar protrusions is fitted into a corresponding one of the rubber recesses, and each of the plurality of the collar recesses is fitted onto a corresponding one of the rubber protrusions so that the rubber member is in close contact with and fitted onto the outer periphery of the collar member, and
a slit is formed on an outer peripheral side of each of the rubber recesses in the rubber member.

2. The anti-vibration rubber according to claim 1, wherein
a protruding portion protruding in a central axis direction of the rubber member is formed on an outer peripheral side of the slit in the rubber member.

3. The anti-vibration rubber according to claim 1, wherein
a stopper portion protruding inward from an outer peripheral side of the slit and facing a corresponding one of the plurality of the collar protrusions is formed on an inner surface of the slit.

4. The anti-vibration rubber according to claim 1, wherein
four collar protrusions are formed at equal intervals around the through-hole, and four collar recesses are formed at equal intervals around the through-hole, the four collar protrusions being the plurality of collar protrusions, the four collar recesses being the plurality of collar recesses.

5. A vehicle comprising:
a vehicle body structural member;
a motor for driving, the motor including an insertion hole;
the anti-vibration rubber according to claim 4, the anti-vibration rubber being inserted into and attached to the insertion hole; and
a fastening member inserted through the through-hole to fasten the anti-vibration rubber to the vehicle body structural member.

6. The vehicle according to claim 5, wherein
the motor includes a bracket; and
the insertion hole is formed in the bracket.

7. The vehicle according to claim 5, further comprising:
a drive shaft coupled with an output shaft of the motor; and
a wheel coupled with the drive shaft, wherein
the drive shaft is provided so as to be inclined in a longitudinal direction of the vehicle as the drive shaft extends outward in a width direction of the vehicle.

8. The vehicle according to claim 7, wherein
the anti-vibration rubber is attached in such a way that each of the plurality of collar protrusions is inclined by 45 degrees with respect to a horizontal direction as viewed in the axial direction of the through-hole.
